(19) United States
(12) Patent Application Publication
(10) Pub. No.: US 2011/0268525 A1
(43) Pub. Date: Nov. 3, 2011

(54) METHODS, SYSTEMS AND APPARATUSES FOR PRODUCING PRODUCTS FROM BLANKS

(76) Inventors: Kim Hanks Karpowitz, Laguna Beach, CA (US); Cameron Todd Karpowitz, Laguna Niguel, CA (US)

(21) Appl. No.: 13/097,611

(22) Filed: Apr. 29, 2011

Related U.S. Application Data
(60) Provisional application No. 61/329,468, filed on Apr. 29, 2010.
(60) Provisional application No. 61/350,859, filed on Jun. 2, 2010.

(51) Int. Cl. A61C 13/38; A61C 13/00

(52) U.S. Cl. 409/225; 428/80; 269/8

(57) ABSTRACT

Embodiments relate to methods and machines for producing cut or milled products, such as medical or dental prostheses, from ceramic or metallic blanks. Some embodiments relate to novel assemblies that may be used with a cutting or milling station to hold blanks for producing products such as medical or dental prostheses. Embodiments also relate to shapes and configurations for such blanks.

### CROSS-REFERENCE TO RELATED APPLICATIONS

This application claims the benefit under 35 U.S.C. §119(e) of provisional applications 61/329,468, entitled Novel Methods, Machines, Components and Blanks, filed Apr. 29, 2010, and 61/350,859, entitled Methods, Systems and Apparatus for Producing Products from Blanks, filed Jun. 2, 2010, both of which are incorporated herein by reference in their entireties for all purposes.

### BACKGROUND

### Field

Embodiments relate to methods and machines for producing cut or milled products, such as medical or dental prostheses, from ceramic or metallic blanks. Some embodiments relate to novel assemblies that may be used with a cutting or milling station to hold blanks for producing products such as medical or dental prostheses. Embodiments also relate to shapes and configurations for such blanks.

### BRIEF DESCRIPTION OF THE DRAWINGS

FIGS. 1A-F show embodiments of a machine for producing cut or milled products according to embodiments.

FIGS. 2A-F show embodiments of a novel assembly that may be used with a cutting or milling machine to hold blanks for producing cut or milled products according to embodiments.

FIGS. 3A-F show blank configurations according to embodiments.

FIG. 4 is a top view of a blank frame according to embodiments.

FIG. 5 is side view of a blank frame taken along the FIG. 5-FIG. 5 line in FIG. 4 according to embodiments.

FIGS. 6A-E show stage frame configurations according to embodiments.

FIG. 7 is a top view of a holding fixture according to embodiments.

FIG. 8 is a rear view of a holding fixture according to embodiments.

### DETAILED DESCRIPTION OF THE PREFERRED EMBODIMENTS

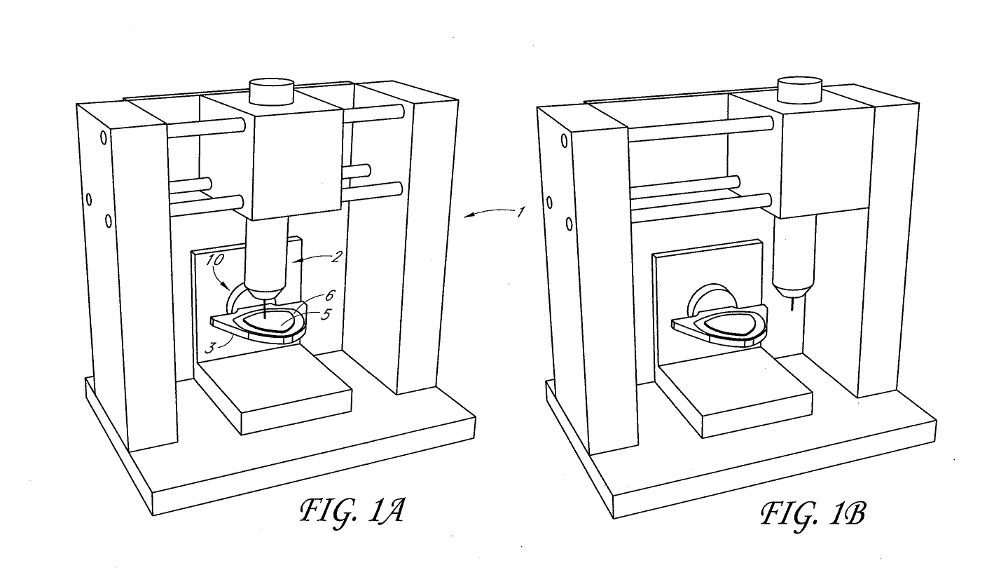

As shown in FIG. 1A, machining unit 1 may be a numerical control device and may comprise a spindle and rotating cutting tool 2 and a holding fixture 3. The machining unit 1 may further comprise a monitor or user interface (not shown). The machining unit 1 may receive instructions form a CAD/CAM system (not shown), including a monitor or user interface associated with the CAD/CAM system. The CAD/CAM techniques and/or systems and related numerical control devices are not particularly limited and can include commercially available systems.

The orientation of the spindle and rotating cutting tool 2 is not particularly limited, and may include a vertical or horizontal orientation. In some embodiments, the machining unit 1 may include two or more spindles and rotating cutting tools. The tool is not particularly limited and may include rotary endmills, drills, rotary saws and broaching tools. The axis of movement of the spindle and rotating cutting tool 2 is not particularly limited and may include movement in one or more of the x, y and z planes. In some embodiments, the spindle and rotating cutting tool is fixed and not movable in the x, y or z planes.

As shown in FIG. 1A, the holding fixture 3 may comprise a rotary assembly 10, which may be used to manually or automatically rotate the holding fixture 3. Embodiments of the rotation of the holding fixture 3 via the rotary assembly 10 are shown in FIGS. 1A-F. The axis of movement of the holding fixture 3 is not particularly limited and may include movement in one or more of the x, y and z planes. In some embodiments, the holding fixture 3 is fixed and not movable in the x, y or z planes.

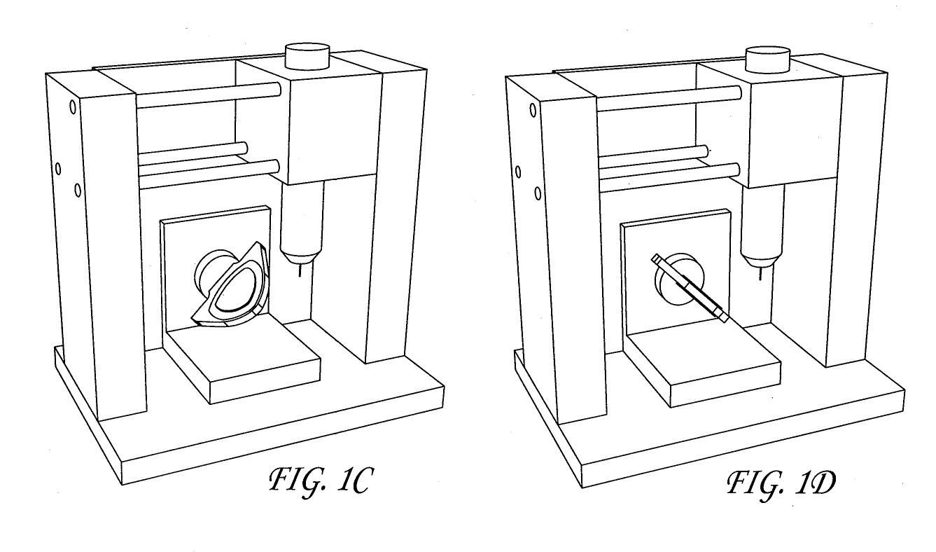

As shown in FIGS. 1A, 2D, and 2E, the holding fixture 3 may be configured to detachably hold a blank 5. The composition of the blank 5 is not particularly limited and may comprise a ceramic material such as zirconium oxide or porcelain, in a sintered or unsintered state, or may comprise machinable waxes, plastics or a metallic material such as titanium or other metals.

The shape of the blank 5 is also not particularly limited and may comprise a three-dimensional shape with straight, angled or curved sides and flat or semi-flat upper and lower surfaces. The upper and lower surfaces of the blank 5 may comprise circles, ovals, triangles, squares, rectangles or other multi-sided shapes. In embodiments comprising upper or lower surfaces in the shape of a triangle, square, rectangle or other multi-sided shape, the sides of the upper and lower surfaces of the blank may be straight or semi-rounded. Also, in embodiments comprising upper or lower surfaces in the shape of a triangle, square, rectangle or other multi-sided shape, the corners of the upper and lower surfaces of the blank may be sharp, semi-rounded or rounded. Finally, in embodiments comprising upper or lower surfaces in the shape of a triangle, the length of the sides of the triangle may be equal or they may be different. In some embodiments, the upper and lower surfaces of the blank 5 comprise the same or similar shapes. In some embodiments, the upper and lower surfaces of the blank comprise different shapes.

The size of the blank 5 is not particularly limited. In some embodiments, the upper and lower surfaces may comprise a diameter (in the case of a circle), major axis (in the case of an oval, ellipse or egg) or height (in the case of a triangle, square, rectangle or other multi-sided shape) of about 10, 20, 30, 40, 50, 60, 70, 80, 90, 100, 110, 120, 150, 200 or 300 mm. In addition, the upper and lower surfaces may comprise a diameter, major axis or height in a range between any of the foregoing values. In some embodiments, the upper and lower surfaces of the blank 5 comprise the same or similar size. In some embodiments, the upper and lower surfaces of the blank 5 comprise different sizes. In some embodiments, the thickness of the blank 5 may comprise about 2, 5, 8, 10, 12, 14, 16, 18, 20, 22, 24, 26, 28, 30, or 40 mm. In addition, the thickness of the blank 5 may comprise a number in a range between any of the foregoing values.

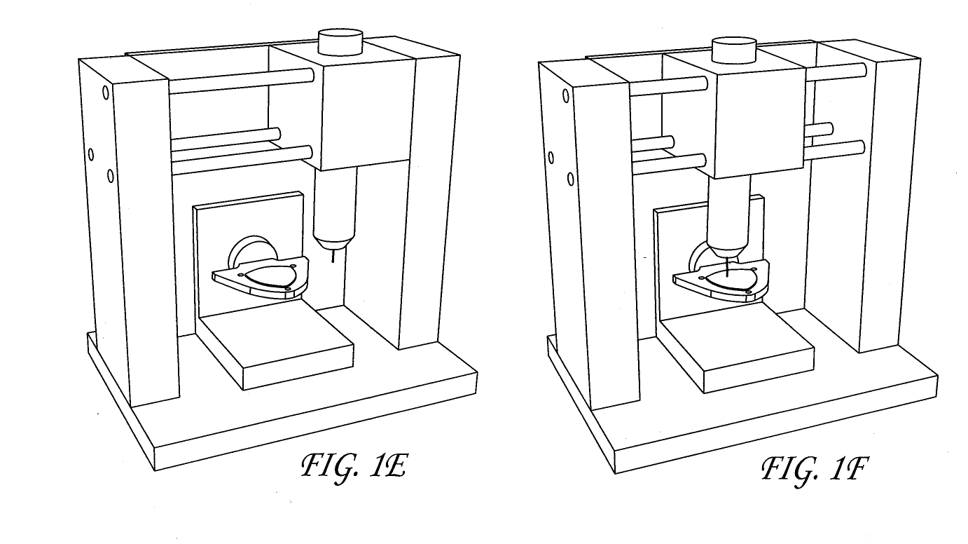

FIGS. 3A-F show embodiments of a blank comprising a surface comprising a trilateral shape. In this application, the term “trilateral shape” is a broad term meaning, without limitation, its plain and ordinary meaning as well as any shape which generally comprises three sides. The sides may comprise the same or different lengths and may be straight or curved. In some embodiments, the sides of a trilateral shape may meet at defined corners. The corners may be at any angle and may be sharp, rounded or flat. The corners may be the same or different in angle or shape.

The length of the sides of the trilateral shape blank (measured as the distance from corner to corner) is not particularly limited and may comprise about 2, 4, 6, 8, 10, 12, 14, 16, 18, 20, 25, 30 or 35 cm. In addition, the length of the sides of the trilateral shape blank may comprise a number in a range between any of the foregoing values. In embodiments where one or more of the sides of the trilateral shape blank is curved, the radius of curvature is not particularly limited and may comprise about 2, 4, 6, 8, 10, 12, 14, 16, 18, 20, 25, 30 or 35 cm. In addition, the radius of curvature of the sides of the trilateral shape blank may comprise a number in a range between any of the foregoing values. In some embodiments, one or more sides of the trilateral shape blank comprise two or more radii of curvature.

In embodiments where one or more of the corners of the trilateral shape blank is rounded or curved, the radius of curvature of the corner is not particularly limited and may comprise about 2, 4, 6, 8, 10, 12, 14, 16, 18, 20, 25, 30 or 35 mm. In addition, the radius of curvature of the corners of the trilateral shape blank may comprise a number in a range between any of the foregoing values.

In embodiments where the blank is used to produce dental prostheses such as multi-piece bridges, the corners of the trilateral shape blank may be shaped to fit the curvature of the jaw. In embodiments involving the production of medical prostheses from blanks, the corners may be shaped to fit the curvature of different body parts.

In some applications, the trilateral shape blank may provide increased manufacturing efficiency by providing the user with guidance for re-insertion into the holding fixture. In some applications involving a numerical control device, the blank may be cut or machined on multiple occasions. In order to ensure proper cutting of the blank upon reinsertion, the blank must be reinstalled in the same orientation each time. Otherwise, the tool may cut over an area that has already been removed or drilled away. If the surface of the blank comprises a trilateral shape, for example, the user may be guided to always insert the blank with one of the corners facing the user or always facing the machine.

Also, in some applications, the trilateral shape may decrease the amount of wasted blank material. In many applications, the blank may comprise expensive material such as zirconium oxide, titanium, etc. Thus, it may be desirable to maximize the use of the material and minimize the waste. For example, in the area of dental prostheses, blanks may be used to manufacture multi-element bridges comprising an arc to fit the curvature of the mouth. In blanks with a surface in the shape of a circle, the edges may not parallel the arc of the bridge, resulting in wasted material. Further, with blanks with a surface in the shape of a square or other multi-sided shape, the corner angles may be too narrow to follow the arc of the bridge, also resulting in wasted material. However, according to embodiments, the blank may comprise a trilateral shape surface with edges and corners configured to more effectively follow the arc of a multi-element bridge, maximizing the use of the blank material.

As shown in FIGS. 2D and 2E, the holding fixture 3 may comprise a stage frame 7 and an opening 8 configured to receive and to detachably hold the blank 5. According to embodiments, the opening 8 is configured to expose both the upper and lower surfaces of the blank 5 when detachably held by the holding fixture 3. In such embodiments, the spindle and rotating cutting tool 2 may be used to cut or machine both surfaces of the blank 5 as the blank is rotated via the holding fixture 3 and the rotary assembly 10. In some embodiments, the machining unit may comprise one or more spindles and rotating cutting tools and may cut or machine both surfaces simultaneously. According to some embodiments, the size and shape of the opening 8 is the same or similar to the size and shape of the blank 5. However, in other embodiments, the size and/or shape of the opening 8 may be different than the size and shape of the blank 5.

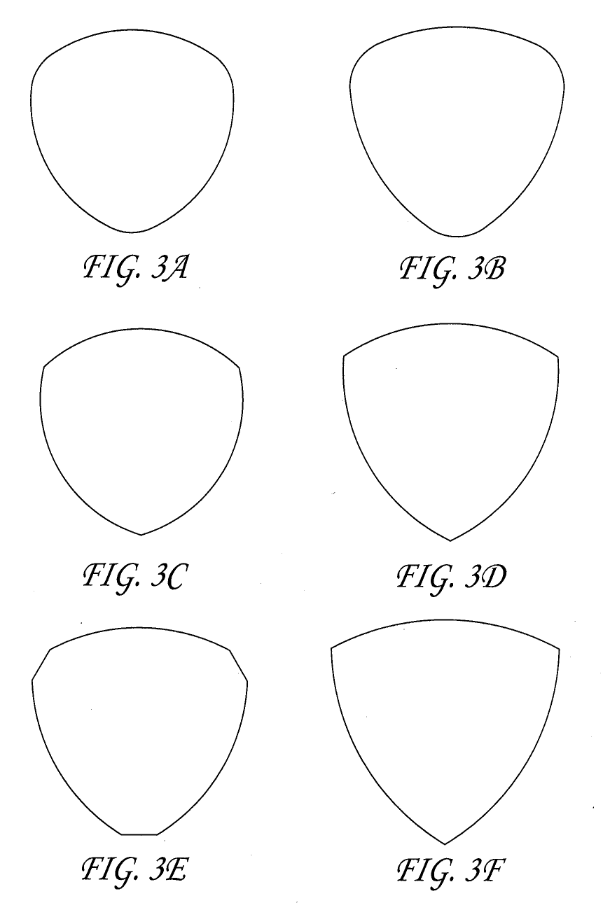

As shown in FIGS. 2C, 2E, and 4-5, the blank 5 may, in some embodiments, comprise a blank frame 6. The blank frame 6 may surround the outer perimeter of the blank 5 and assist in the detachable retention of the blank 5 in the holding fixture 3. The blank frame 6 may, as shown in FIG. 5, extend the entire thickness of the blank 5, or it may only extend a portion of the thickness of the blank 5. The thickness of the blank frame 6 is not particularly limited. The length of the lip of the blank frame 6 extending out from the periphery of the blank 5 is not particularly limited and may comprise a length of about 1, 2, 3, 4, 5, 6, 7, 8, 9, 10, 12, 15, 20, 25 or 30 mm. In addition, the lip of the blank frame 6 may comprise a length in a range of any of the foregoing numbers. In some embodiments, the blank frame may be configured to hold two or more blanks. In some embodiments, the shape of the outer perimeter of the blank frame may be similar to the shape of the blank. In other embodiments, the shape of the outer perimeter of the blank frame may be different than the shape of the blank.

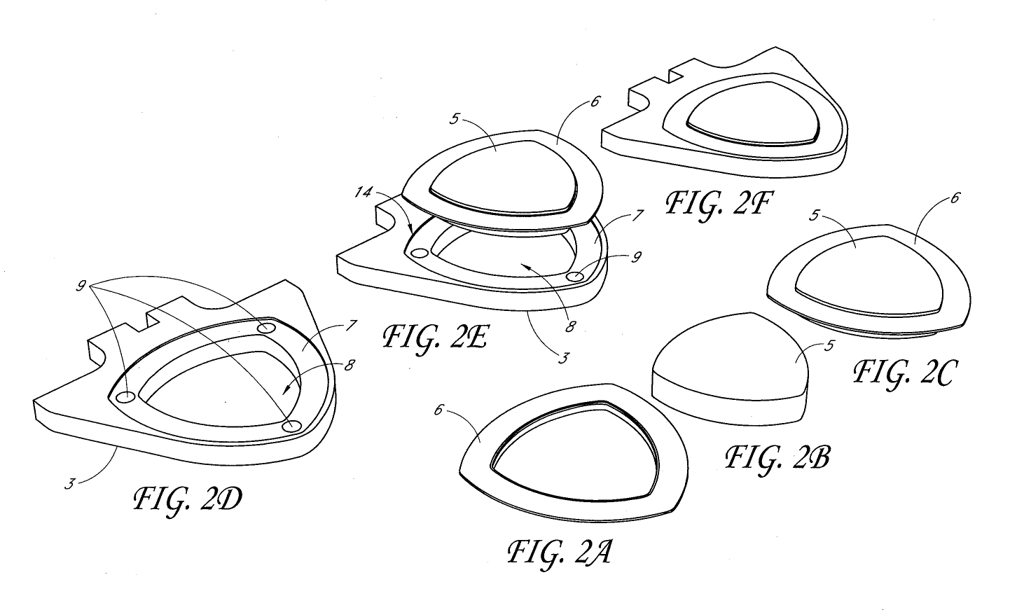

FIG. 4 shows embodiments of a blank frame configured to hold a trilateral shape blank. As shown in FIG. 4, the blank frame comprises an inner perimeter 11 and an outer perimeter 12. The side length (as measured from corner to corner), side curvature and corner shape/curvature of the inner perimeter 11 are not limited and may comprise any of the side lengths, side curvatures or corner shapes/curvatures as described above with respect to the trilateral shape blank.

The side length (as measured from corner to corner) of the outer perimeter 12 is larger than the side length of the inner perimeter 11. The difference in side length between the inner and outer perimeters is not limited and may comprise about 1, 2, 3, 4, 5, 6, 7, 8, 9, 10, 12, 15, 20, 25 or 30 mm. In addition, the difference in side length may comprise a number in a range between any of the foregoing values. The side curvature and corner shape/curvature of the outer perimeter 12 may comprise any of the side curvatures or corner shape/curvatures as described above with respect to the trilateral blank. In some embodiments, the side curvature and corner shape/curvature of the inner perimeter 11 matches the side curvature and corner shape/curvature of the outer perimeter 12. In other embodiments the side curvatures and corner shapes/curvatures of the two perimeters differ.

The blank frame 6 may be chemically or mechanically fixed to the blank 5. In some embodiments, the blank frame 6 is chemically fixed to the blank 5 through the use of one or more adhesives. In other embodiments, the blank frame 6 is mechanically fixed to the blank through clamping or other mechanical means.

In some embodiments, the blank frame 6 may be prepared by stamping or cutting the shape so that the inner perimeter of the frame is somewhat smaller than the perimeter of the blank 5. The inner perimeter of the blank frame 6 may then be bent or pressed upward, using extrusion or deep draw dies or other tools, through the opening so that the inner perimeter will fit the periphery of the blank 5 and provide a surface for attaching the blank frame 6 to the blank 5.

In other embodiments, the blank frame 6 may be prepared by molding or casting the starting material(s).

In some embodiments, the blank frame may comprise sheet metal. In other embodiments, the blank frame may comprise plastic. In certain embodiments where the blank frame comprises plastic, the blank frame may comprise pieces of metal embedded or incorporated into the blank frame.

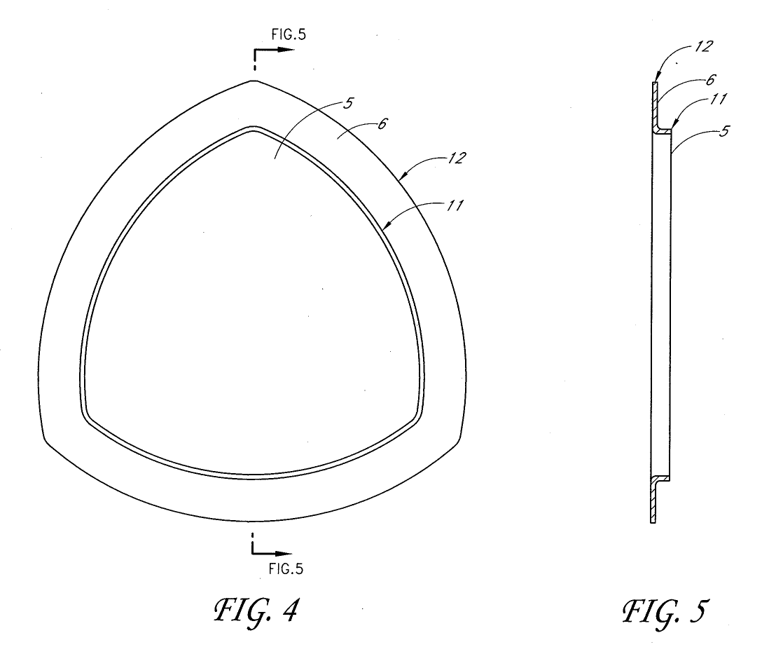

The blank frame 6 may be attached to the stage frame 7 through various mechanisms such as clamps, screws or magnets. As shown in FIGS. 2D, 2E, and 6A-E, the stage frame 7 may, in some embodiments, comprise one or more magnets 9 to interact with and hold the blank frame 6 in place. The location of the magnets is not limited to the stage frame 7 and may include other areas of the holding fixture 3. In other embodiments, the blank frame 6 may comprise one or more magnets 9 to interact with and hold to the stage frame 7. In certain embodiments where the blank frame 6 comprises one or more magnets to interact and hold to the stage frame 7, the blank frame 6 may comprise a plastic or ceramic material.

The size, location and number of magnets are not particularly limited. In some embodiments, magnets 9 may be placed evenly around the opening of the stage frame 7 or the blank frame 6. In some embodiments, the stage frame 7 or blank frame 6 may comprise one magnet 9 surrounding the opening 8 or the blank 5, respectively. In some embodiments, the one or more magnets 9 may comprise bar magnets, in other embodiments, the one or more magnets 9 may comprise cylinder magnets. In certain embodiments comprising bar or cylinder magnets, the magnets and the interaction between the blank frame and stage frame may be activated and/or deactivated through mechanical means such as a rotating cam.

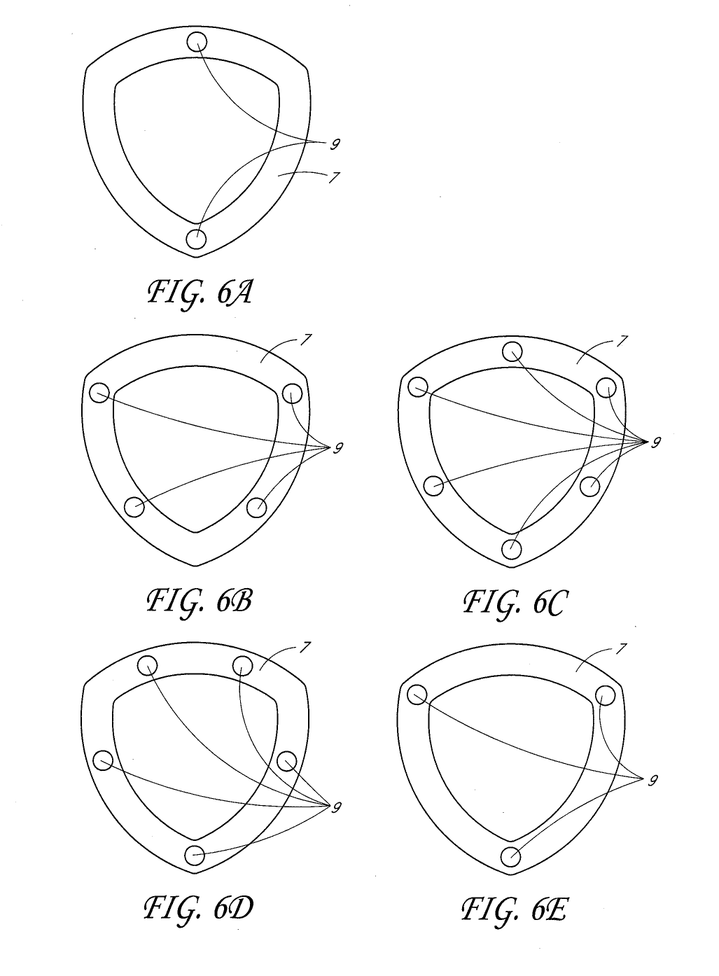

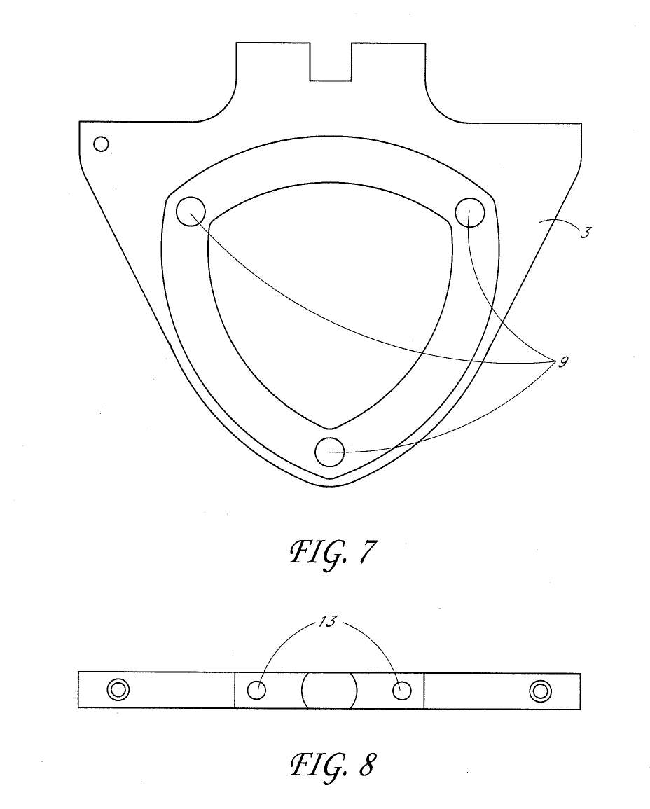

In some embodiments, the one or more magnets 9 may comprise one or more electromagnets. The size, location and number of electromagnets are not limited. In some embodiments, the electromagnets may be connected to and powered by a power source in the machining unit 1. In some embodiments, the electromagnets may be connected to a power source in the machining unit 1 via wires embedded in and traveling through the holding fixture 3. FIGS. 7 and 8 show embodiments comprising a holding fixture 3 with holes 13 entering through the rear of the holding fixture 3 through which wires may be connected to the one or more magnets 9.

In some embodiments, the power source connected to the one or more electromagnets may be controlled by the user using a monitor or user interface. In these embodiments, the user may activate the electromagnets via the monitor or user interface and place the blank frame 6 and blank 5 on the holding fixture 3 to secure the blank 5 during machining. In order to remove the blank frame 6 and blank 5, the user may deactivate the electromagnets via the monitor or user interface.

As shown in FIG. 2E, the holding fixture 3 may comprise a recess or depression 14 to correlate with the shape of the blank frame 6. In other embodiments, the holding fixture is flat and does not comprise a recess or depression.

In some embodiments, the blank frame and stage frame may comprise components configured to consistently orient the blank in the holding fixture. In some embodiments, the blank frame and stage frame may comprise a lock and key component to assist in the consistent orientation of the blank. In certain embodiments, the blank frame may comprise a hole or groove and the stage frame may comprise a corresponding pin or protrusion to interact with the hole or groove in the blank frame. In other embodiments, the blank frame may comprise a pin or protrusion and the stage frame may comprise a corresponding hole or groove.

FIGS. 2A-F show a sequence of preparing the machining unit assembly according to some embodiments. The sequence of steps in not limited and can be performed in any order. The steps are described with respect to the figures simply for illustrative purposes and are not intended to be limited to the steps shown. In some embodiments, the blank frame 6, as shown in FIG. 2A, may be attached to the blank 5, as shown in FIG. 2B, to form the blank assembly, as shown in FIG. 2C. The blank assembly can then be placed in the holding fixture 3, as shown in FIGS. 2D-E, and detachably held via magnets 9 which may be activated using a computer monitor or interface. The connected blank assembly and holding fixture is shown in FIG. 2F.

What is claimed is:

1. A system for producing products from blanks comprising:
a machining unit;
a spindle and rotating cutting tool; and
a holding fixture, wherein the holding fixture is configured to receive and detachably hold a blank via magnetic force.

2. A blank comprising a trilateral shape.

3. A blank ring, wherein the blank ring is configured to interact with a holding fixture via magnetic force.

4. A blank assembly for producing products comprising:
a blank comprising a trilateral shape; and
a blank ring, wherein the blank ring is configured to interact with a holding fixture via magnetic force.
